(19) United States
(12) Patent Application Publication
(10) Pub. No.: US 2012/0123793 A1
(43) Pub. Date: May 17, 2012

(54) METHOD AND APPARATUS FOR CLINICAL DECISION SUPPORT FOR PATIENT BEHAVIOR MODIFICATION

(75) Inventors: Lloyd Neil Werk, Longwood, FL (US); James Robert Miller, Kissimmee, FL (US)

(73) Assignee: The Nemours Foundation, Orlando, FL (US)

(21) Appl. No.: 13/293,293

(22) Filed: Nov. 10, 2011

Related U.S. Application Data
(60) Provisional application No. 61/412,883, filed on Nov. 12, 2010.

(51) Int. Cl. G06Q 50/22

(52) U.S. Cl. 705/2

(57) ABSTRACT

Apparatus, computer readable medium, and a method for clinician decision support for behavior modification of a patient, the method including in response to receiving information identifying the patient, retrieving stored patient data from a database, and displaying portions of the retrieved patient data for a clinician to update during a clinical session; and, in response to receiving a selection for finding a new target behavior to achieve the goals of the patient, displaying a plurality of target behaviors for the patient to achieve the goals of the patient; and, in response to receiving a selection of one of the plurality of displayed target behaviors as the new target behavior, adding the selected one of the plurality of displayed target behaviors to the target behaviors of the patient. The method may facilitate the conduct of behavioral modification counseling by eliciting patient feedback and recording patient progress in negotiated tasks.

This application is related to and claims priority from U.S. Provisional Application No. 61/412,883, filed on Nov. 12, 2010, the entire disclosure of which is incorporated herein by reference.

### FIELD

The invention relates to apparatuses, computer readable medium, and methods for behavior modification, and more specifically to apparatuses and methods for clinician decision support for behavior modification.

### BACKGROUND

In the discussion of the background that follows, reference is made to certain structures and/or methods. However, the following references should not be construed as an admission that these structures and/or methods constitute prior art. Applicants expressly reserve the right to demonstrate that such structures and/or methods do not qualify as prior art.

Behavior modification is used for treating various conditions including obesity and addiction to tobacco. Additionally, behavior modification is used in routine patient education to encourage healthy eating and lifestyle choices, and to improve adherence to medication schedules.

Behavior modification therapy includes finding behaviors that the patient is willing and capable of changing. This can be both time consuming and difficult.

The difficulty can be exasperated because often different counselors will treat the same patient, and the different counselors may have difficulty in understanding the notes and evaluations from other counselors. Additionally, often counselors do not follow the same agenda when treating patients which may confuse the patient and make it difficult to evaluate the results of counseling.

### SUMMARY

Therefore, there is a need in the art for the following methods, computer readable medium, and apparatuses. A method on a computer for clinician decision support for behavior modification of a patient is disclosed. The method includes in response to receiving information identifying the patient, retrieving stored patient data from a database, and displaying portions of the retrieved patient data for a clinician to update during a clinical session, said displayed data comprising goals of the patient, target behaviors of the patient to achieve the goals, and a readiness of the patient to adopt the target behaviors; in response to receiving a selection for finding a new target behavior to achieve the goals of the patient, displaying a plurality of target behaviors for the patient to achieve the goals of the patient; in response to receiving a selection of one of the plurality of displayed target behaviors as the new target behavior, adding the selected one of the plurality of displayed target behaviors to the target behaviors of the patient; and storing the selected one of the plurality of displayed target behaviors to the database.

The step in response to receiving a selection for finding a new target behavior to achieve the goals of the patient may include in response to receiving a selection for finding a new target behavior to achieve the goals of the patient, displaying an agenda for the clinician to follow to identify the new target behavior, and displaying a plurality of target behaviors for the patient to achieve the goals of the patient.

The step in response to receiving a selection for finding a new target behavior to achieve the goals of the patient may include selecting a predetermined script relating to the goals of the patient and a strategy, the predetermined script for the clinician or patient to follow to identify a new target behavior to achieve the goals of the patient, wherein the new target behavior is associated with the strategy.

The agenda may include instructions for how the clinician should interact with the patient.

The step in response to receiving a selection for finding a new target behavior to achieve the goals of the patient may include in response to receiving a selection for finding a new target behavior to achieve the goals of the patient, displaying a plurality of target behaviors for the patient to achieve the goals of the patient, and in response to the clinician entering a readiness of the patient to modify the patient's behavior for at least one of the displayed plurality of target behaviors, selecting one of the plurality of displayed target behaviors as the new target behavior based on the readiness of the patient to modify the patient's behavior for the at least one of the displayed plurality of target behaviors, and adding the selected one of the plurality of displayed target behaviors to the target behaviors of the patient.

The step in response to the clinician entering the readiness of the patient to modify the patient's behavior for at least one of the displayed plurality of target behaviors may include in response to the clinician entering the readiness of the patient to modify the patient's behavior for at least one of the displayed plurality of target behaviors, selecting one of the plurality of displayed target behaviors as the new target behavior based on the readiness of the patient to modify the patient's behavior for the at least one of the displayed plurality of target behaviors, and adding the selected one of the plurality of displayed target behaviors to the target behaviors of the patient, and adding the selected one of the plurality of displayed target behaviors to at least one of: a visit's notes, to a progress notes, and to a patient's instructions.

The step in response to the clinician entering the readiness of the patient to modify the patient's behavior for at least one of the displayed plurality of target behaviors may include in response to the clinician entering the readiness of the patient to modify the patient's behavior for at least one of the displayed plurality of target behaviors, selecting one of the plurality of displayed target behaviors as the new target behavior based on the readiness of the patient to modify the patient's behavior for the at least one of the displayed plurality of target behaviors, and adding the selected one of the plurality of displayed target behaviors to the target behaviors of the patient, and adding to a patient's instructions for the selected one of the plurality of displayed target behaviors key messages and resources to help the patient.

The step in response to receiving information identifying the patient and an indication of a beginning of a clinical session may include in response to receiving information identifying the patient and an indication of a beginning of a clinical session, retrieving stored patient data from a database, and displaying portions of the retrieved patient data for a clinician to update during the clinical session, said displayed data comprising goals of the patient, a goal status indicator, target behaviors of the patient to achieve the goals, and a readiness of the patient to adopt the target behaviors.

The step in response to receiving a selection for finding a new target behavior to achieve the goals of the patient may include in response to receiving a selection for finding a new target behavior to achieve the goals of the patient, displaying a matrix of strategies, and in response to receiving readiness selections for a plurality of strategies displayed in the matrix of strategies, identifying at least one of the plurality of strategies for the patient to achieve the goal, and displaying a plurality of target behaviors for the patient to achieve the goals of the patient, wherein the displayed plurality of target behaviors for the patient to achieve the goals of the patient are selected based on the identified strategy.

The step in response to receiving a selection for finding a new target behavior to achieve the goals of the patient may include displaying a readiness ruler.

The step in response to receiving a selection for finding a new target behavior to achieve the goals of the patient may include displaying an agenda for the clinician to follow to identify a strategy from the matrix of strategies.

The step in response to receiving a selection for finding a new target behavior to achieve the goals of the patient may include in response to receiving a selection for finding a new target behavior to achieve the goals of the patient, displaying a plurality of target behaviors for the patient to achieve the goals of the patient, wherein the plurality of target behaviors are selected from a library of target behaviors.

The step in response to receiving a selection of one of the plurality of displayed target behaviors as the new target behavior may include in response to receiving a selection of one of the plurality of displayed target behaviors as the new target behavior, adding the selected one of the plurality of displayed target behaviors to the target behaviors of the patient, wherein the selection of the one of the plurality of displayed target behaviors is based on a readiness of the patient to adopt the selected one of the plurality of displayed target behaviors.

The method may include in response to receiving updates to displayed patient data, updating the patient data with the received updates, and adding the received updates to at least one of: a visit's notes, and a progress notes. The method may include sending to the patient via at least one of email or a text message an aggregation of updated displayed patient data.

The method may include prompting the clinician to update retrieved patient data.

The step in response to receiving a selection for finding a new target behavior to achieve the goals of the patient may include in response to receiving a selection for finding a new target behavior to achieve the goals of the patient, displaying a plurality of domains, and in response to receiving a selection of one of the plurality of displayed domains, displaying a matrix of strategies, and in response to receiving readiness selections for a plurality of strategies displayed in the matrix of strategies, identifying one of the plurality of strategies for the patient to achieve the goal, and displaying a plurality of target behaviors for the patient to achieve the goals of the patient, wherein the displayed plurality of target behaviors for the patient to achieve the goals of the patient are selected based on the identified strategy.

A computer program product is disclosed. The computer program product may include a computer-readable medium including a first set of codes for responding to receiving information identifying a patient by retrieving stored patient data from a database, and displaying portions of the retrieved patient data for a clinician to update during a clinical session, said displayed data comprising goals of the patient, target behaviors of the patient to achieve the goals, and a readiness of the patient to adopt the target behaviors; a second set of codes for responding to receiving a selection for finding a new target behavior to achieve the goals of the patient by displaying a plurality of target behaviors for the patient to achieve the goals of the patient; a third set of codes for responding to receiving a selection of one of the plurality of displayed target behaviors as the new target behavior by adding the selected one of the plurality of displayed target behaviors to the target behaviors of the patient; and a fourth set of codes for storing the selected one of the plurality of displayed target behaviors to the database.

A computer system for clinician decision support for behavior modification of a patient is disclosed. The computer system may include a processor adapted to: respond to receiving information identifying the patient by retrieving stored patient data from a database, and displaying portions of the retrieved patient data for a clinician to update during a clinical session, said displayed data comprising goals of the patient, target behaviors of the patient to achieve the goals, and a readiness of the patient to adopt the target behaviors; respond to receiving a selection for finding a new target behavior to achieve the goals of the patient by displaying a plurality of target behaviors for the patient to achieve the goals of the patient; respond to receiving a selection of one of the plurality of displayed target behaviors as the new target behavior by adding the selected one of the plurality of displayed target behaviors to the target behaviors of the patient; and store the selected one of the plurality of displayed target behaviors to the database.

The processor may further be adapted to: display an agenda for the clinician to follow to identify a new target behavior for the patient to achieve the goal and displaying target behaviors for the patient to achieve the goal.

The processor may be adapted for the step to respond to receiving a selection for finding a new target behavior to achieve the goals of the patient, by displaying a plurality of target behaviors for the patient to achieve the goals of the patient, and to respond to the clinician entering a readiness of the patient to modify the patient's behavior for at least one of the displayed plurality of target behaviors by selecting one of the plurality of displayed target behaviors as the new target behavior based on the readiness of the patient to modify the patient's behavior for the at least one of the displayed plurality of target behaviors, and adding the selected one of the plurality of displayed target behaviors to the target behaviors of the patient.

### BRIEF DESCRIPTION OF THE DRAWING

The following detailed description can be read in connection with the accompanying drawings in which like numerals designate like elements and in which:

FIG. 1 illustrates a method for behavior modification according to an embodiment of the invention.

FIG. 2 illustrates a user interface with patient data for a clinician to update during a clinical session according to an embodiment of the invention.

FIG. 3 illustrates a user interface displaying a pull-down menu of a library of target behaviors the patient may select from according to an embodiment of the invention.

FIG. 4 illustrates a user interface with an agenda for the clinician to follow, domains which may be selected, and a readiness ruler according to an embodiment of the invention.

FIG. 5 illustrates a user interface for the “Eating Domain”, which is part of a weight management tool according to an embodiment of the invention.

FIG. 6 illustrates the user interface for the strategy “Meals” according to an embodiment of the invention.

FIG. 7 illustrates a user interface which presents information regarding how to implement a “Go, Slow, Whoa Foods” target behavior according to an embodiment of the invention.

FIG. 8 illustrates user interface 800, which may have been invoked by user interface 300, 500 or 600, where a target behavior has been selected and added to a new target behavior of the patient according to an embodiment of the invention.

FIG. 9 illustrates the target behavior added as a target behavior of the patient by the selection of the “Add New” button according to an embodiment of the invention.

FIG. 10 illustrates a user interface for a target behavior of the patient being updated by the clinician according to an embodiment of the invention.

FIG. 11 illustrates notes that may be kept relating to the patient according to an embodiment of the invention.

FIG. 12 illustrates a system for behavior modification according to an embodiment of the invention.

FIG. 13 is a simplified functional block diagram of a computer system according to an embodiment of the invention.

### DETAILED DESCRIPTION

Although described in connection with preferred embodiments thereof, it will be appreciated by those skilled in the art that additions, deletions, modifications, and substitutions not specifically described may be made without departure from the spirit and scope of the invention as defined in the appended claims.

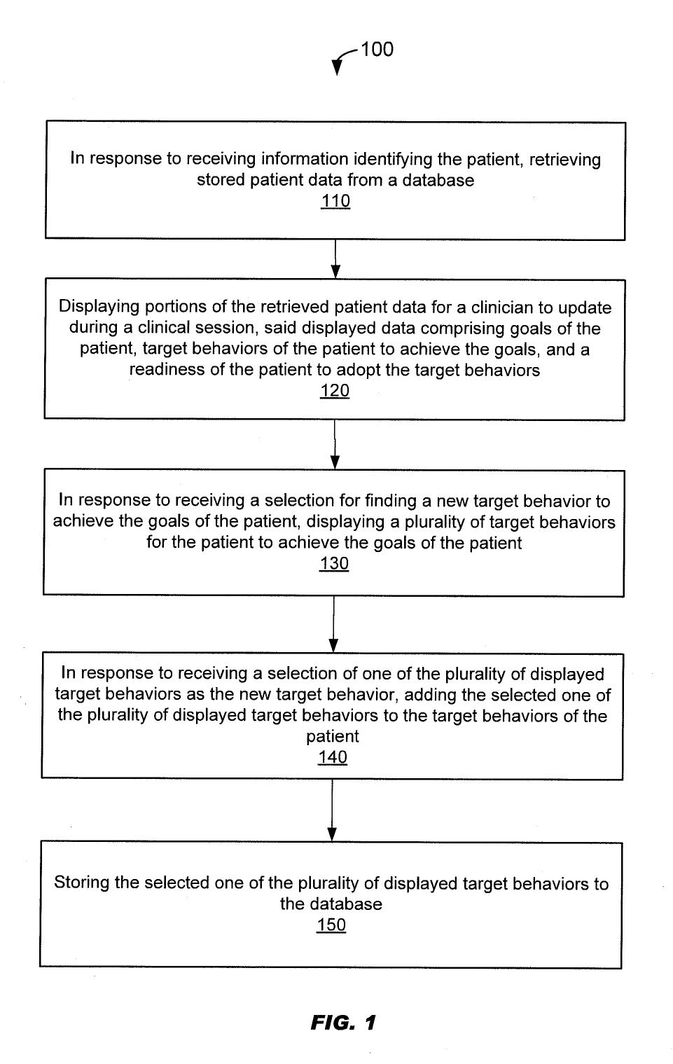

FIG. 1 illustrates a method for behavior modification according to an embodiment of the invention. The method 100 begins with 110 in response to receiving information identifying the patient, retrieving stored patient data from a database. For example, a clinician may enter the patient's name and other identifying information which may be used to retrieve stored patient data from a database.

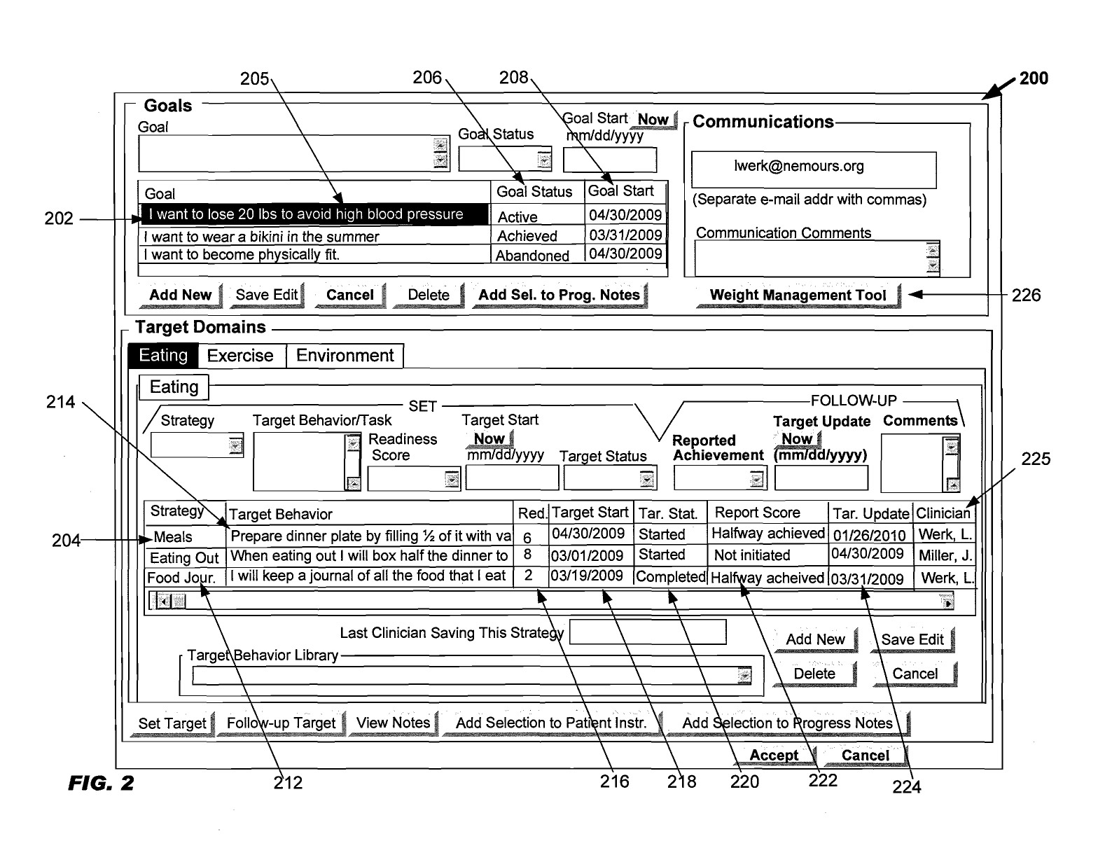

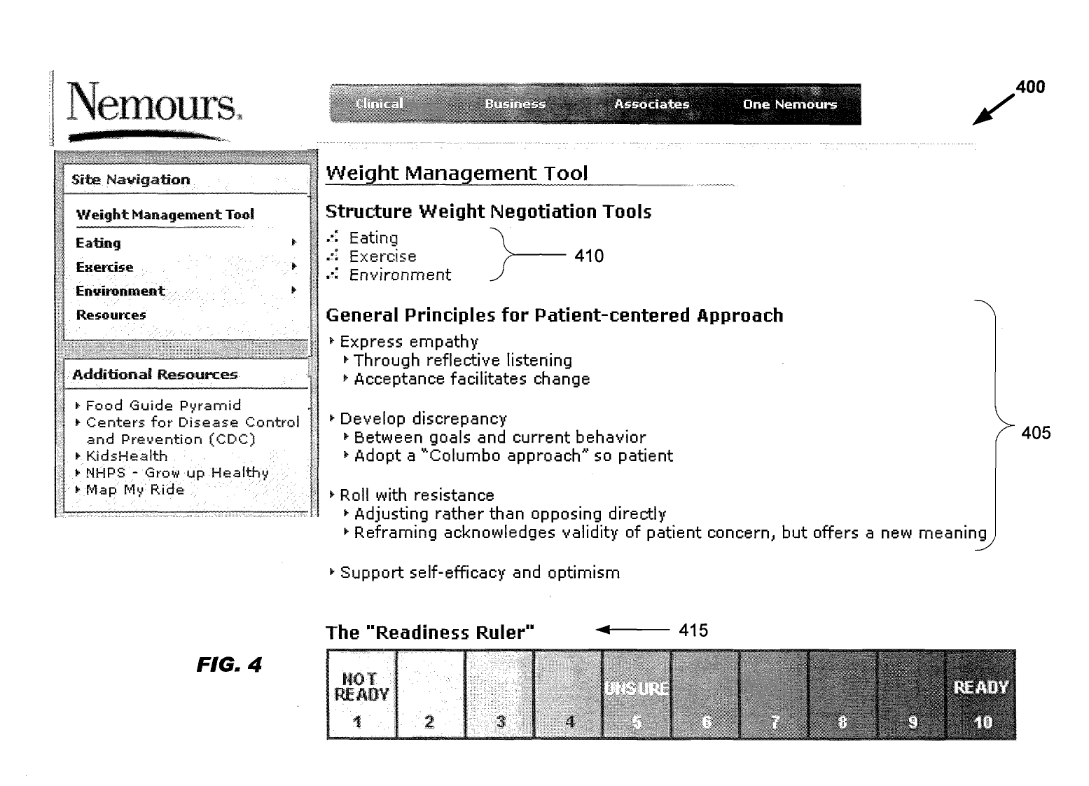

The method 100 continues with 120 displaying portions of the retrieved patient data for a clinician to update during a clinical session, said displayed data comprising goals of the patient, target behaviors of the patient to achieve the goals, and a readiness of the patient to adopt the target behaviors. FIG. 2 illustrates a user interface with patient data for a clinician to update during a clinical session. Illustrated in FIG. 2 is the user interface 200, patient goals 202, with goal status indicator 206, and a date when the goal was started 208, target behavior 204, which includes a strategy 212, a target behavior description 214, a readiness of the patient to adopt the target behavior 216, a target start 220, a report score 222, a target update 224, and a last clinician saving this strategy 225. The user interface 200 may include a button 226 for finding a new target behavior to achieve one of the goals of the patient. The button 226 may invoke a clinical decision support tool which may set an agenda and trigger discussion. An example of a clinical decision support tool is discussed in relation to FIGS. 4-7. The button 226 is labeled “Weight Management Tool” since the current condition is weight control; however, the button 226 may be labeled differently according to the condition that is being treated. For example, if the condition being treated were sickle cell then the button 226 may be labeled “Sickle Cell Management Tool” whose selection may invoke a sickle cell management tool, where the sickle cell management tool may include domains medication adherence and pain management corresponding to the eating, exercise, and environment domains of the weight management tool.

Patient goals 202 are goals 202 the patient would like to achieve. The patient goals 202 may be personal goals such as a desire for the patient to lose 20 pounds as illustrated in FIG. 2. The patient goals 202 may have a goal description 205, a goal status indicator 206, which is patient data for the clinician to update during the clinical session. The goal description 205 may include a description of the goal such as “I want to lose 20 lbs. to avoid high blood pressure.” The goal status indicator 206 may have several different values which here are “active”, “abandoned”, and “achieved.” The value of the goal status indicator 206 may include other values such as “deferred”. As illustrated the goal status indicator 206 of patient goal 202 “I want to lose 20 pounds to avoid high blood pressure” is “active” 206. The goal status indicator 206 of patient goal 202 “I want to become physically fit” is “abandoned” 206. The goal status indicator 206 may be patient data for the clinician to update during the clinical session. The patient goals 202 may have goal start 208 which is the date on which the patient goal 202 was started. For example, for the patient goal 202 “I want to become physically fit” the goal start 208 is “Apr. 30, 2009.” In embodiments, the patient goal 202 may be entered by the patient or the clinician.

The target behavior 204 is a behavior that is targeted for modification that the patient has agreed to try and adopt as a new behavior. In embodiments, the target behavior 204 may be a negative behavior that the patient has agreed to stop doing. The target behavior 204 may have a strategy 212, which is a strategy for achieving the patient goals 202. For example, for the target behavior 204 with target behavior description 214 “prepare dinner plate by filling ½ of it with vegetables”, the strategy is “meals” 204. The target behavior 204 may have a readiness 216 which is a readiness for the patient to adopt the target behavior 204. For example, for the target behavior 204 with target behavior description 214 “prepare dinner plate by filling ½ of it with vegetables” the readiness 216 is “6” which may indicate an above average readiness for the patient to adopt the target behavior 204. The readiness 216 may be patient data for the clinician to update during the clinical session. The target behavior 204 may have a target start 218 which is a date for the patient to begin modifying their behavior to adopt the target behavior 204. For example, for target behavior 204 with target behavior description 214 “prepare dinner plate by filling ½ of it with vegetables” the target start 218 is “Apr. 30, 2009”. The target behavior 204 may have a target status 220, which indicates the current status of the target behavior 204. For example, for target behavior 204 with the target behavior description 214 “prepare dinner plate by filling ½ of it with vegetables” the target status 220 is “Started”, which indicates the patient is trying to adopt the target behavior. The target status 220 may be patient data for the clinician to update during the clinical session. The target behavior 204 may have a report score 222 which may indicate a level of achievement of the target behavior 204 by the patient. The report score 222 may have values of “not initiated”, “some achieved”, “halfway achieved”, “mostly achieved”, and “fully achieved.” In embodiments, report score 222 may have other values. For example, for target behavior 204 “prepare dinner plate by filling ½ of it with vegetables” 214, the report score 222 is “halfway achieved”, which indicates the patient has modified their behavior about halfway in adopting the target behavior. The report score 222 may be patient data for the clinician to update during the clinical session.

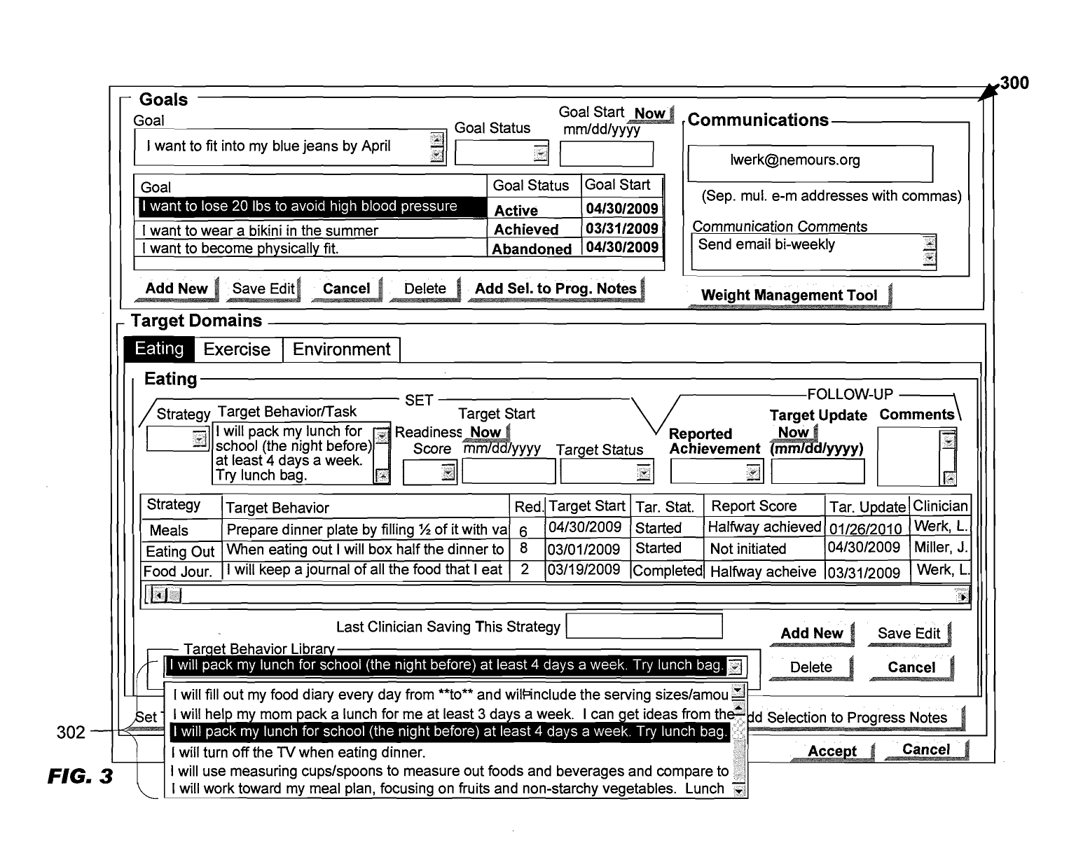

The target behavior 204 may have a target update 224, which indicates the date when the target status 220 was updated. For example, for target behavior 204 with target behavior description 214 “prepare dinner plate by filling ½ of it with vegetables” 214, the target update 224 is “Jan. 26, 2010”, which indicates the date the target behavior 204 was updated. The target update 224 may be patient data for the clinician to update during the clinical session. The target behavior 204 may have a last clinician saving this strategy 225, which indicates the last clinician to save changes to the target behavior 204. The target behavior 204 may be entered directly, retrieved from a target behavior library 302 (see FIG. 3), and optionally modified, or retrieved from a saved targeted behavior 204 and optionally modified.

In operation, the user interface 200 is displayed after the clinician enters information identifying the patient. The user interface 200 provides patient data for the clinician to update during the clinical session. By examining the user interface 200 the clinician can insure that the patient data that should be updated during a clinical session with the patient is updated.

Referring back to FIG. 1, the method 100 continues with 130 in response to receiving a selection for finding a new target behavior to achieve the goals of the patient, displaying a plurality of target behaviors for the patient to achieve the goals of the patient.

For example, FIG. 3 illustrates a user interface 300 displaying a pull-down menu of a library of target behaviors 302 the patient may select from. The library of target behaviors 302 may be expandable with new strategies and target behaviors by, for example, the clinician, or administratively. The library of target behaviors 302 may be include strategies and/or target behaviors 302 that are specific to a patient and/or clinician or that are included for all patients and/or clinicians. The clinician and patient may discuss the readiness of the patient to adopt the target behaviors in the library of target behaviors 302.

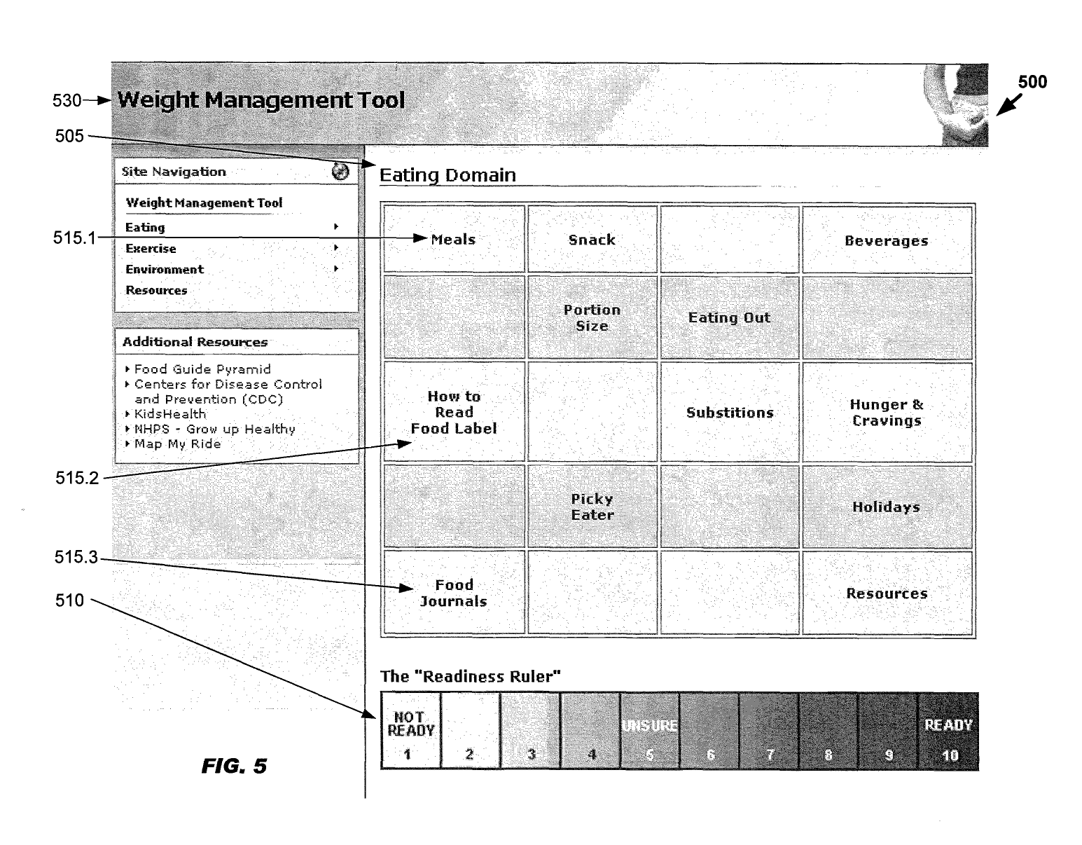

Additionally, step 130 may optionally include as illustrated, in FIG. 4, that the clinician may ask the patient for the patient's readiness to adopt one of the three domains 410 listed, “Eating”, “Exercise”, and “Environment.” The user interface 400 may invoke another user interface 500 based on the readiness selections. In embodiments, the clinician may select a domain 410 directly. FIG. 4 may have been invoked by the selection of button “Weight Management Tool” 226. FIG. 5 illustrates a user interface 500 for the “Eating Domain” 505, which is part of a weight management tool 530. Illustrated in FIG. 5 are strategies 515 and a readiness ruler 510. The clinician may ask the patient using the agenda for the clinician to follow 405 (see FIG. 4) the readiness of the patient to adopt a strategy to modify the patient's behavior. For example, the clinician may ask the patient of the patient's readiness for “Meals” 515.1, “How to read Food Label” 515.2, and “Food Journals” 515.3. The patient may respond with a 6 (six) for “Meals” 515.1, a 2 (two) for “How to read Food Label” 515.2, and a 1 (one) for “Food Journals” 515.3. Since the patient's readiness is highest for “Meals” 515.1, a behavior may be explored that relates to modifying the strategy “Meals” 515.1 of the patient.

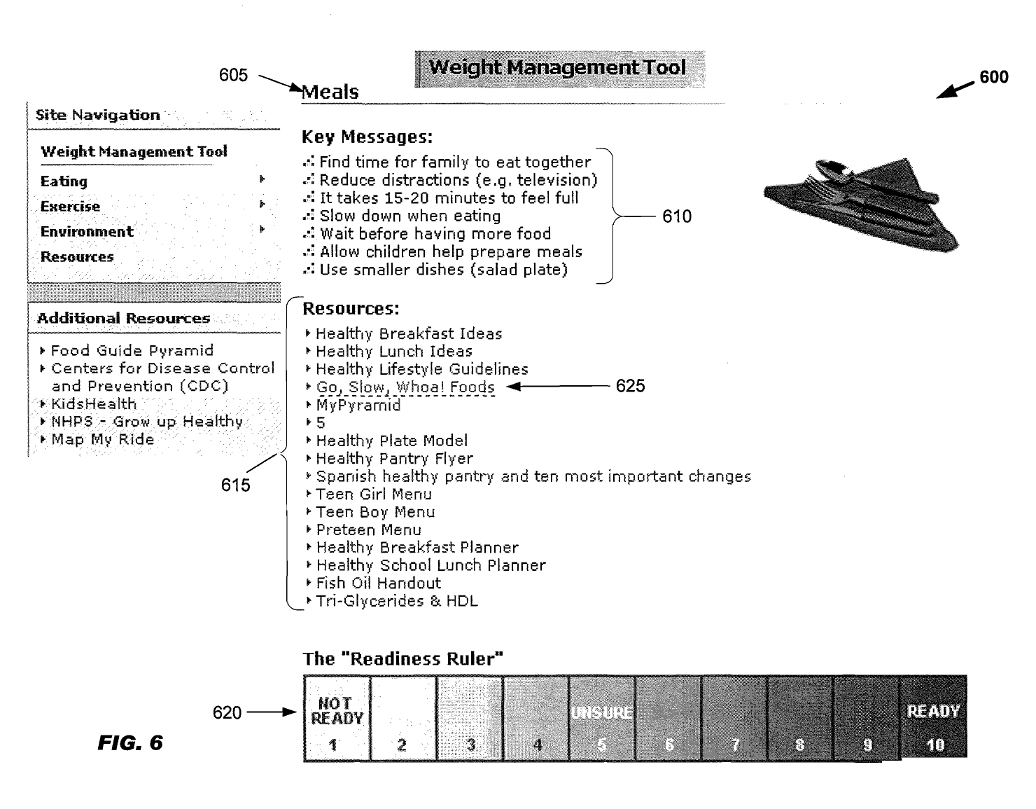

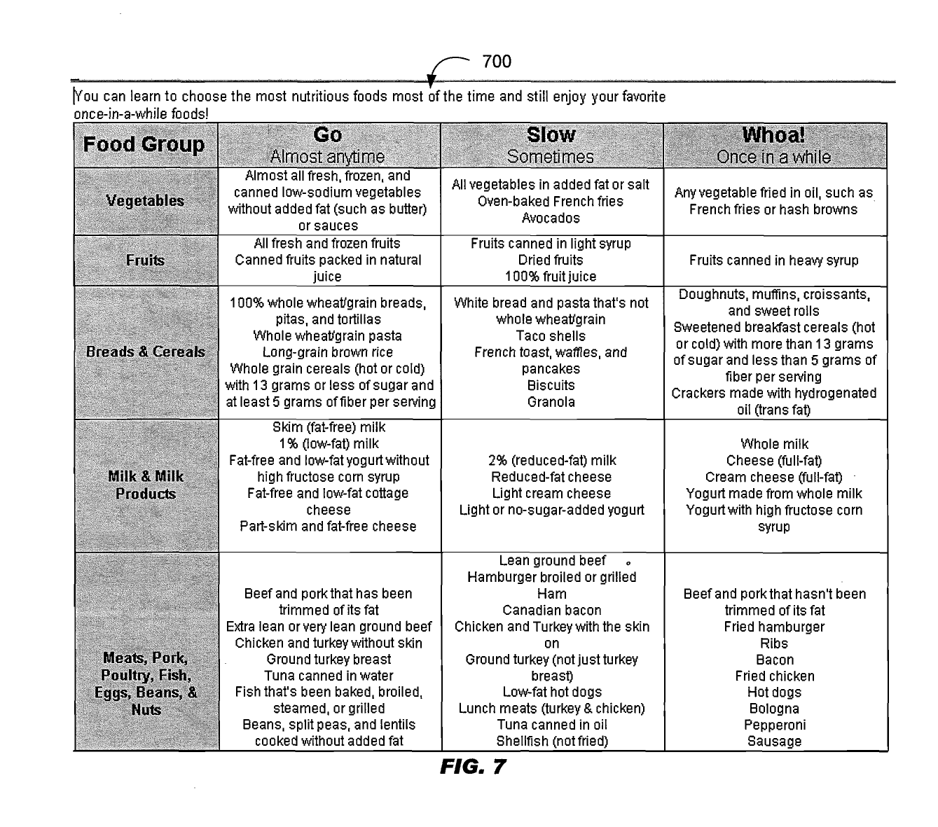

The user interface 500 may invoke the user interface 600 (FIG. 6) or the clinician may invoke the user interface 600 directly. Each of the boxes, for example “Meals” 515.1, “How to read Food Label” 515.2, and “Food Journals” 515.3, may link to a clinical support page with an appropriate user interface for the selected strategy. FIG. 6 illustrates the user interface 600 for the strategy “Meals” 605. The user interface 600 may include “Key Messages” 610 to convey to the patient, “Resources” 615 for education and finding target behaviors, and a readiness ruler 620. The “Resources” 615 may be linked to provide further information for possible target behaviors. The clinician may determine the readiness of the patient to adopt a target behavior from the “Resources” 615. A “Resources” 615 may be selected to provide additional information regarding the “Resource” 615. For example, selecting “Go, Slow, Whoa Foods” 625 may invoke the user interface 700 of FIG. 7. FIG. 7 illustrates a user interface which presents information regarding how to implement a “Go, Slow, Whoa Foods” 625 target behavior. The clinician and the patient may explore the different “Resources” 615 with the clinician recording a readiness of the patient to adopt a behavior from the “Resources” 615 using the readiness ruler 620. Here, the “Go, Slow, Whoa Foods” 625 may be selected based on the readiness of the patient to adopt the target behavior.

In embodiments, there may not be domains or strategies. A target behavior may be found in another way. For example, a library of target behaviors that had been used by patients to achieve similar goals as the patient's goal may be displayed and explored for a target behavior. Alternatively or in addition, step 130 may include selecting a predetermined script relating to the goals of the patient, the predetermined script for the clinician or patient to follow to identify a new target behavior to achieve the goals of the patient, wherein the target behavior is associated with a strategy. For example, the script may lead the clinician through the steps outlined above for step 130. The script may be in a computer language or in a pseudo-code for aiding lay people in creating and maintaining the scripts.

Referring back to FIG. 1, the method 100 continues with 140 in response to receiving a selection of one of the plurality of displayed target behaviors as the new target behavior, adding the selected one of the plurality of displayed target behaviors to the target behaviors of the patient.

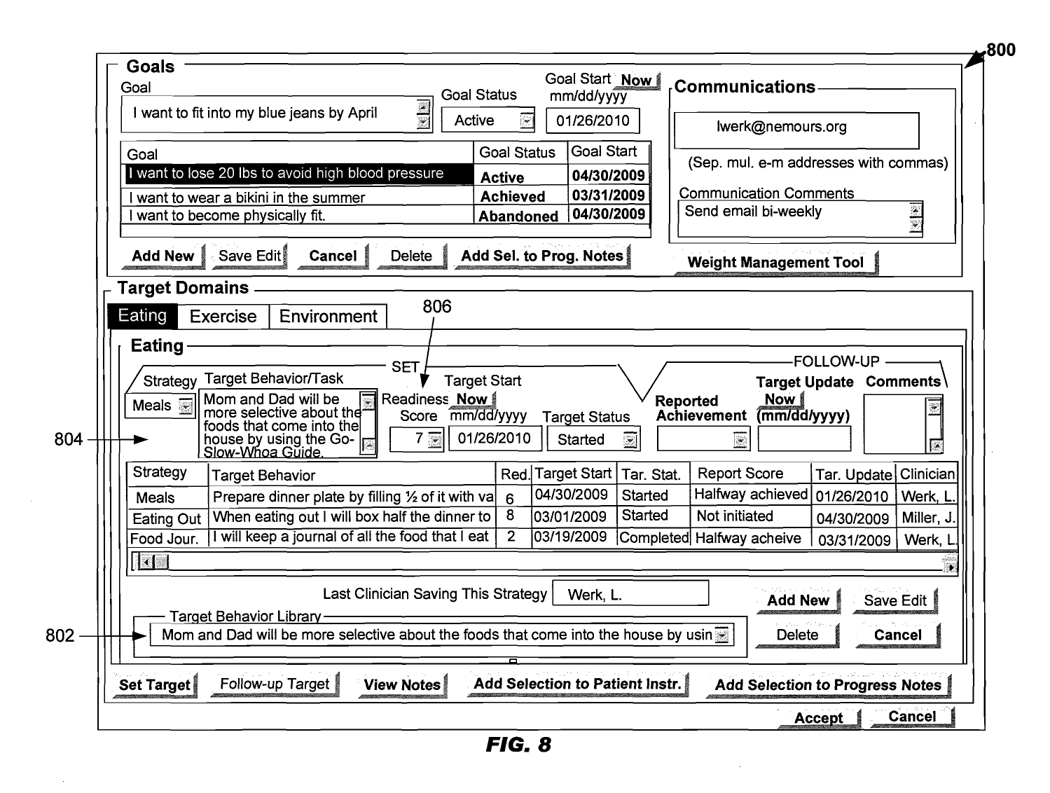

For example, FIG. 8 illustrates user interface 800, which may have been invoked by user interface 300, 500 or 600, where a target behavior 802 has been selected in this case from the target behavior library and has populated the new target behavior 804, so that the new target behavior 804 and associated fields may be edited prior to being added as a new target behavior 804 of the patient. Alternatively, the clinician may have entered free hand the target behavior in the Target Behavior/Task text box 804. The clinician may negotiate the target behavior 804 with the patient and/or the patient's family. The selection of the new target behavior of the patient 804 may have been based on the readiness of the patient to adopt the new target behavior 804. Here the readiness of the patient to adopt the new target behavior is a 7 (seven) 806.

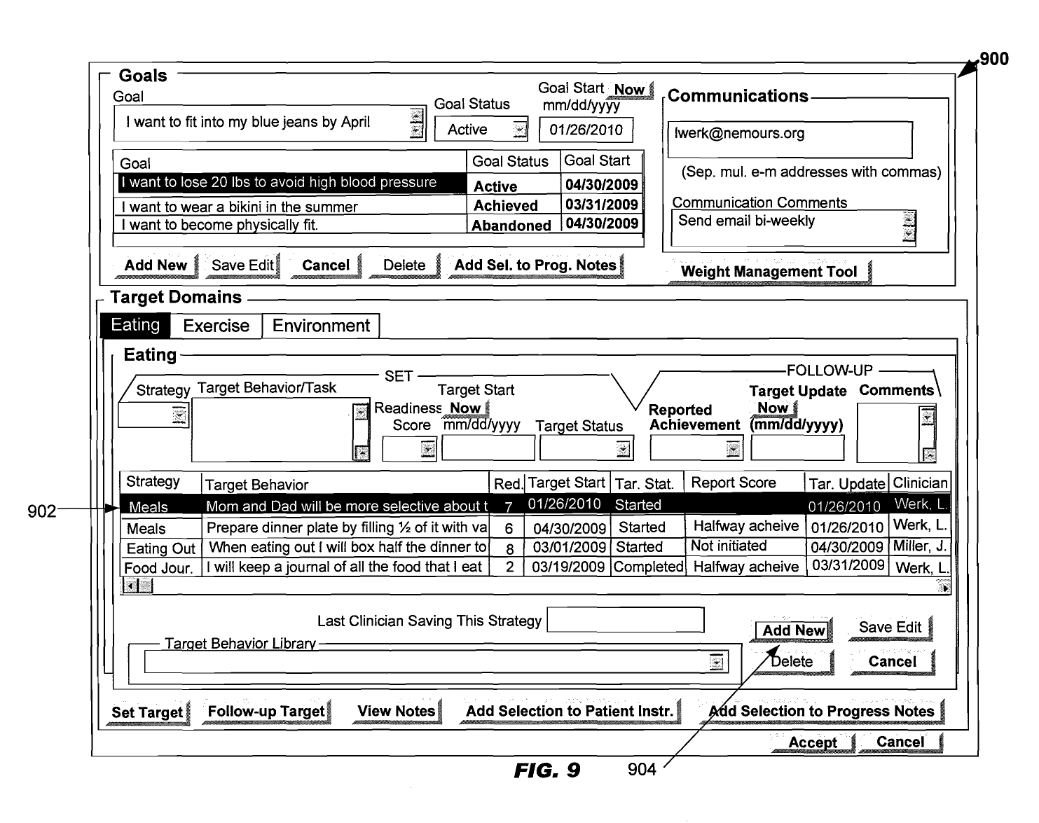

FIG. 9 illustrates the target behavior 802 added as a target behavior 902 of the patient by the selection of the “Add New” button 904.

Referring back to FIG. 1, the method 100 continues with 150 storing the selected one of the plurality of displayed target behaviors to the database. The new target behavior may be stored in a database by the selection of “Add New” button 904.

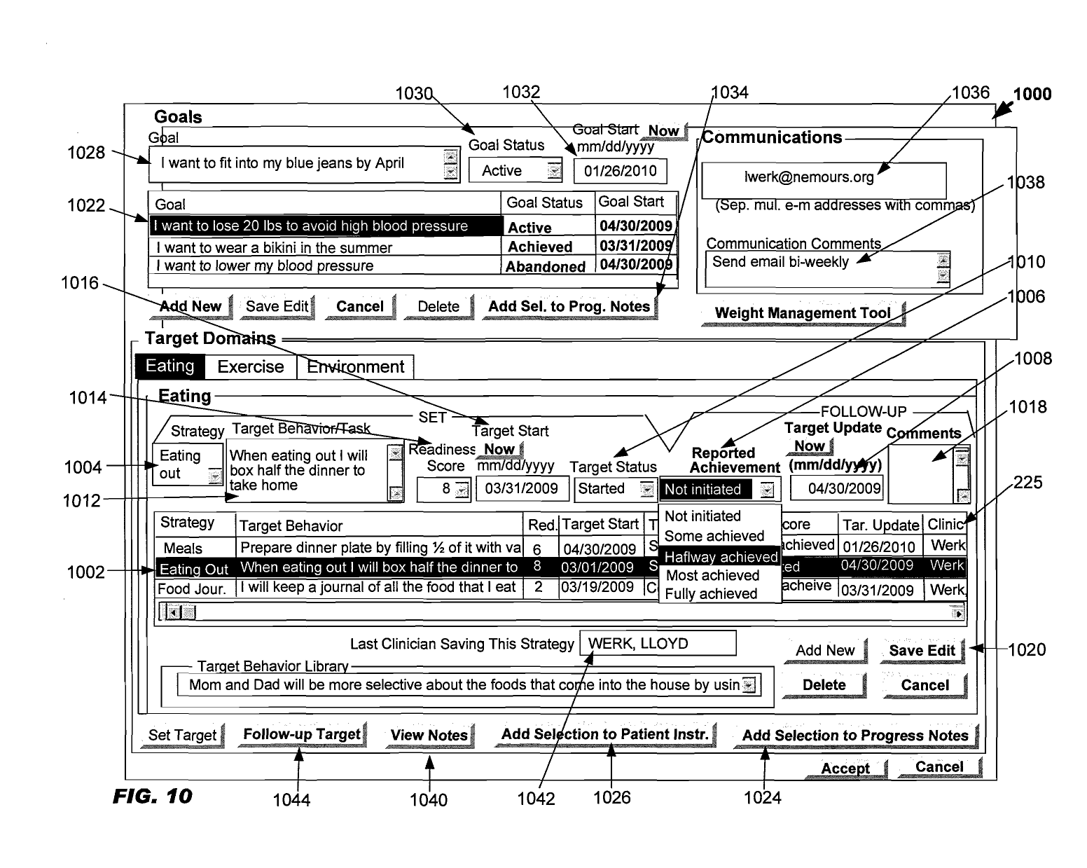

FIG. 10 illustrates a user interface for a target behavior of the patient being updated by the clinician. Illustrated in FIG. 10 is a user interface 1000 with a selected target behavior 1002 being updated. The button “Follow-up Target” 1044 may have been selected to select the target behavior 1002. The target behavior 1002 may have been selected in other ways. For example, a mouse may have been placed over the target behavior 1002 and a right click button may have been pressed to display a menu of actions that could be taken on the target behavior 1002 one of which may have been “Follow-up Target”. The target behavior being updated 1002 is copied to a top portion 1004 for ease of updating the fields of the target behavior 1002 being updated. A clinical session may be taking place between a clinician and a patient. The displayed goals 1022 and target behaviors 1002 indicate to the clinician what needs to be updated during the clinical session. The clinician may be updating the field “Reported Achievement” 1006 from “not initiated” to “halfway achieved” 1006. The clinician's name 1042 may be recorded as the last clinician saving this strategy 225. The clinician name 1042 may be populated based on a logon into the system. The other fields of the target behavior 1002 may similarly be updated. For example, “Strategy” 1004, “Target Behavior/Task” 1012, “Readiness Score” 1014, “Target Start” 1016, “Target Status” 1010, “Target Update” 1008, and “Comments” 1018. The updates or edits may be saved by selecting the “Save Edit” button 1020. Additionally, the selected target behavior 1002 can be added to progress notes by selecting “Add selection to Prog. Note” 1024. The selected target behavior 1002 can be added to patient instructions by selecting “Add selection to Patient Instructions” 1024.

Additionally, a selected goal 1022 can be edited or updated. For example, the “Goal” text 1028 may be edited, the “Goal Status” 1030, and the “Goal Start” 1032 may be edited. Selection of the “Add selection to progress Notes” 1034 will add the selected goal 1022 to the progress notes of the patient.

Moreover, a “Communications” address 1036 may be edited for the patient and a “Communication Comments” 1038 may be edited. The “Communications Comments” 1038 may indicate how often to send reminders or requests for updates to the patient at the one or more addresses given in the “Communications” address 1036. The “Communications” address 1036 may be email addresses, text addresses, or another form of address that may be used to contact the patient with for example aggregated tasks for patient instructions.

In embodiments, the user interface 1000 will prompt the clinician to update each of the active goals and active target behaviors. The clinician may negotiate each of the inputs to the user interface 1000 including updates and new target behaviors with the patient and/or the family of the patient.

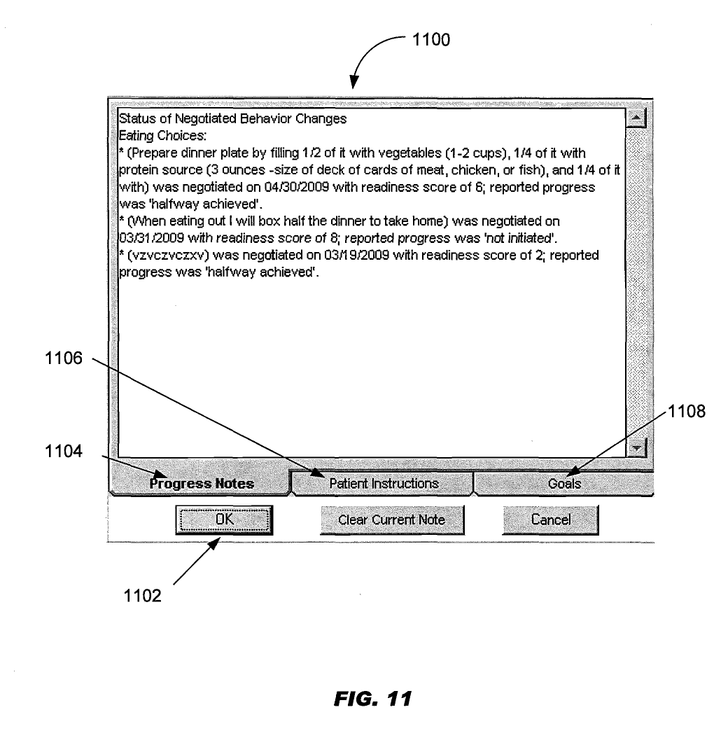

FIG. 11 illustrates notes that may be kept relating to the patient. Illustrated in FIG. 11 is a user interface 1100 for viewing and editing “Progress Notes” 1104, “Patient Instructions” 1106, and “Goals” 1108. The user interface 1100 may be invoked by, for example, selection of the button 1040 in FIG. 10. The “Progress Notes” 1104 may record activity for a clinical session. For example, the “Progress Notes” 1104 may include target behaviors that are added by the clinician selecting a button or automatically when updates or new goals or target behaviors are added. The “Progress Notes” 1104 may be converted by the system into discrete sentences with words such as “was negotiated” or “status of” added to the “Progress Notes” 1104 to facility readability. The clinician may edit the “Progress Notes” 1104. The “Patient Instructions” 1106 may be instructions for the patient that are added by the clinician selecting a button or automatically when updates or new goals or target behaviors are added. The “Patient Instructions” 1106 may include negotiated target behaviors that active. The “Patient Instructions” 1106 may be converted by the system into sentences with surrounding verbiage such as “Patient agreed.” Information that may help the patient may be included in the “Patient Instructions” 1106. The clinician may edit the “Patient Instructions” 1106. The “Goals” 1108 may be the current goals of the patient. The clinician may edit the “Goals” 1108. There may be other notes such as clinical session notes. All the activity occurring in the method and apparatus may be recorded either automatically or manually by the clinician. The notes may facilitate the clinical session by providing a convenient record of the clinical session and a convenient set of instructions for the patient. The notes may reflect the name of the clinician that made the updates or added new goals and/or new target behaviors. The “Progress Notes” 1104, “Patient Instructions” 1106, and “Goals” 1108, may be aggregated and sent to be included in a electronic medical record of the patient. Optionally, only changed “Progress Notes” 1104, “Patient Instructions” 1106, and “Goals” 1108, may be aggregated and sent to the electronic medical record of the patient. The “Progress Notes” 1104, “Patient Instructions” 1106, and “Goals” 1108, may be communicated to the patient by for example, emailed or texted, according to one or more addresses 1036 (see FIG. 10) of the patient and optionally according to “communication comments” 1038. In embodiments, the patient may be required to respond to the communication with a progress update or indication of compliance.

In embodiments, other conditions other than obesity such as inflammatory bowel disease (“IBD”) and diabetes are provided for. Embodiments of the invention have the advantage of being able to share the progress of a patient between different clinicians since the updates are less subjective and more objective measures of the patients progress. Embodiments of the invention have the advantage that the method and apparatus provide for the clinician an agenda to follow during the clinical session. Embodiments, of the invention have the advantage that it elicits patient feedback and records patient progress in negotiated tasks, and provides clinical decision support to help clinicians in communication, and provides patients & clinicians feedback on their progress.

Embodiments of the invention provide the advantage that the data is granular so that the data can be shared between clinicians and used in research. Additionally, modifications to the patient data may be tracked and shared during and between clinical sessions between clinicians.

Embodiments of the invention provide the advantage of an agenda setting matrix, a readiness ruler, printable patient notes and handouts, and the ability to link to external websites for finding information and target behaviors.

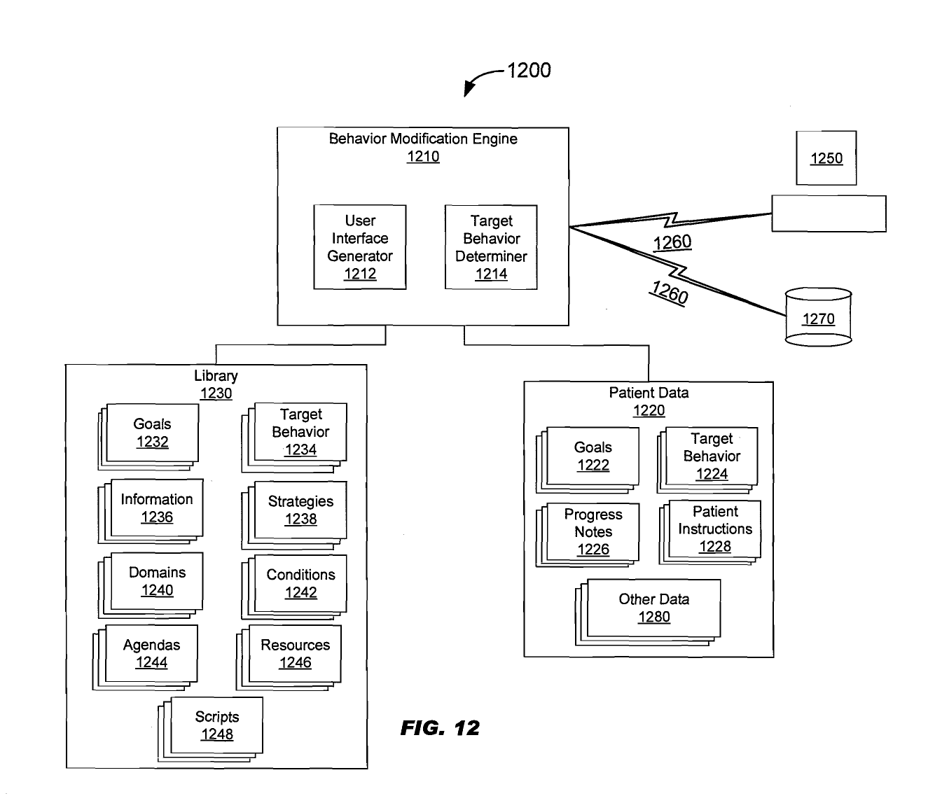

FIG. 12 illustrates a system for behavior modification. Illustrated in FIG. 12 is a behavior modification engine 1210, which includes a user interface generator 1212 and a target behavior determiner 1214; a library 1230, which includes goals 1232, target behavior 1234, information 1236, strategies 1238, domains 1240, conditions 1242, agendas 1244, resource 1246, and scripts 1248; patient data 1220, which includes goals 1222, target behavior 1224, progress notes 1226, patient instructions 1228, and other data 1280; a computer 1260; an Internet 1270; and, a communication link 1260. The behavior modification engine 1210 access the patient data 1220 and library 1230 and presents user interface screens on the computer 1260 for interacting with a clinician and patient.

The behavior modification engine 1210 may be configured to take a patient's name and other identifying information and retrieve stored patient data 1220. The behavior modification engine 1210 may be configured to display portions of the patient data 1220 for the clinician to update during a clinical session including goals 1222 which may include a goal status indicator and target behaviors 1224 of the patient to achieve the goals with a readiness of the patient to adopt the target behaviors. The behavior modification engine 1210 may be configured to display the patient data 1220 in a matrix and may be configured to prompt the clinician to update patient data 1220 that should be updated during a clinical session. The behavior modification engine 1210 may be configured to assist the clinician and patient in finding from the library 1230 new target behaviors 1234, goals 1232, information 1236, strategies 1238, domains 1240, and conditions 1242. The behavior modification engine 1210 may be configured to perform the method of FIG. 1. The behavior modification engine 1210 may be configured to search for target behaviors 1234 for a patient to achieve a goal 1222. The behavior modification engine 1210 may be configured to search for goals 1232 for conditions 1242. The behavior modification engine 1210 may be configured to display an agenda for identifying a new target behavior. The behavior modification engine 1210 may be configured to display strategies 1238 and a readiness ruler for evaluating the readiness of the patient to adopt a strategy 1238. The behavior modification engine 1210 may configured to display library 1230 items in a matrix format. The behavior modification engine 1210 may be configured to maintain progress notes 1226 and the patient instructions 1228. The behavior modification engine 1210 may be configured to record the activity occurring in the method and apparatus either automatically or manually by the clinician. The behavior modification engine 1210 may be configured to access the library 1230 over the Internet 1270 and may be configured to search for and/or access additional information over the Internet 1270 to supplement the library 1230 or any of the items in the library 1230. The behavior modification engine 1210 may be configured to send email or text all or portions of the patient data 1220 to the patient based on the patient addresses 1036.

The user interface generator 1212 may be configured to generate user interfaces for displaying on the computer 1250. The target behavior determiner 1214 may be configured to determine a target behavior for the patient to attempt to adopt based on responses from the patient of the readiness of the patient to adopt either specific target behaviors or strategies.

The communication link 1260 may be a communication link as described below. The Internet 1270 may be the internet networking of computers. The computer 1260 may be a computer system such as a lap top or desk top.

Scripts 1248 may be in a computer language or in a pseudo-code for aiding lay people in creating and maintaining the scripts. The scripts 1248 may lead the clinician through the steps outlined above for selecting a strategy and/or target behavior.

The patient data 1220 may include goals 1222, target behavior 1224, progress notes 1226, patient instructions 1228, and other data 1280. The other data 1280 may include all the data described herein associated with a patient which includes strategies, readiness, date initiated, follow-up achievement, target update date, comments, modifications, and other data such as the person that has made the modifications and an audit trail of all the changes that have been made to the patient data which may include but is, not limited to, information regarding the clinical sessions.

The patient data 1220 may be accessible to an external email server (not illustrated) which may be configured to email or text the patient based on addresses of the patient. The patient data 1220 including progress notes 1226 and patient instructions 1228 may be sent to or received from or duplicated by an external patient portal (not illustrated) that may include electronic medical records for the patient. The external patient portal may be on an intranet with the behavior modification engine 1210.

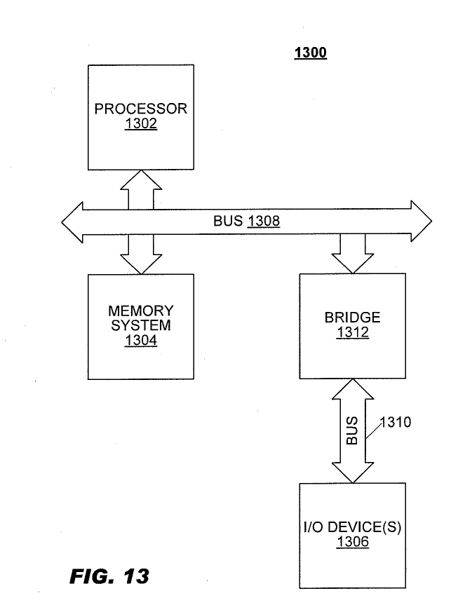

FIG. 13 is a simplified functional block diagram of a computer system 1300. The system for behavior modification can be implemented in hardware, software or some combination thereof.

As shown in FIG. 13, the computer system 1300 includes a processor 1302, a memory system 1304 and one or more input/output (I/O) devices 1306 in communication by a communication ‘fabric.’ The communication fabric can be implemented in a variety of ways and may include one or more computer buses 1308, 1310 and/or bridge devices 1312 as shown in FIG. 13. The I/O devices 1306 can include network adapters and/or mass storage devices. Referring to FIGS. 12 and 13, the computer system 1300 may receive access library items and/or additional items to supplement the library as well as the computer 1260 over the network adapters 1306. The library 1230 and patient data 1220 may reside on memory system 1304 and/or on I/O devices 1306. For example, the library 1230 may include a database of target behaviors 1234. The database may be organized and accessible according to commercial available database products. The database of target behaviors 1234 may reside on a mass storage device that is part of the memory system 1304, or may reside on a mass storage device that is accessible via the communication fabric and part of the I/O devices 1306, which may be either local such as a hard disk in the same room as the processor 1302 or may be located remotely such as in a memory system such as a hard disk remotely located in a service center. The communication fabric may be in communication with many networks including the Internet and local area networks.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium, which may be in a physical form.

Although the clinician has been described as performing the interaction with the user interfaces it should be understood that the patient or another person such as a clerical assistant could perform the actual interaction with the user interfaces.

Although described in connection with preferred embodiments thereof, it will be appreciated by those skilled in the art that additions, deletions, modifications, and substitutions not specifically described may be made without departure from the spirit and scope of the invention as defined in the appended claims.

What is claimed is:

1. A method on a computer for clinician decision support for behavior modification of a patient, the method comprising:
in response to receiving information identifying the patient, retrieving stored patient data from a database, and displaying portions of the retrieved patient data for a clinician to update during a clinical session, said displayed data comprising goals of the patient, target behaviors of the patient to achieve the goals, and a readiness of the patient to adopt the target behaviors;
in response to receiving a selection for finding a new target behavior to achieve the goals of the patient, displaying a plurality of target behaviors for the patient to achieve the goals of the patient;
in response to receiving a selection of one of the plurality of displayed target behaviors as the new target behavior, adding the selected one of the plurality of displayed target behaviors to the target behaviors of the patient; and
storing the selected one of the plurality of displayed target behaviors to the database.

2. The method of claim 1, wherein the step in response to receiving a selection for finding a new target behavior to achieve the goals of the patient, comprises:
in response to receiving a selection for finding a new target behavior to achieve the goals of the patient, displaying an agenda for the clinician to follow to identify the new target behavior, and displaying a plurality of target behaviors for the patient to achieve the goals of the patient.

3. The method of claim 1, wherein the step in response to receiving a selection for finding a new target behavior to achieve the goals of the patient, comprises:
in response to receiving a selection for finding a new target behavior to achieve the goals of the patient, selecting a predetermined script relating to the goals of the patient and a strategy, the predetermined script for the clinician or patient to follow to identify a new target behavior to achieve the goals of the patient, wherein the target behavior is associated with the strategy.

4. The method of claim 3, wherein the agenda includes instructions for how the clinician should interact with the patient.

5. The method of claim 1, wherein the step in response to receiving a selection for finding a new target behavior to achieve the goals of the patient, comprises:
in response to receiving a selection for finding a new target behavior to achieve the goals of the patient, displaying a plurality of target behaviors for the patient to achieve the goals of the patient, and
in response to the clinician entering a readiness of the patient to modify the patient's behavior for at least one of the displayed plurality of target behaviors, selecting one of the plurality of displayed target behaviors as the new target behavior based on the readiness of the patient to modify the patient's behavior for the at least one of the displayed plurality of target behaviors, and adding the selected one of the plurality of displayed target behaviors to the target behaviors of the patient.

6. The method of claim 5, wherein the step in response to the clinician entering the readiness of the patient to modify the patient's behavior for at least one of the displayed plurality of target behaviors, comprises:
in response to the clinician entering the readiness of the patient to modify the patient's behavior for at least one of the displayed plurality of target behaviors, selecting one of the plurality of displayed target behaviors as the new target behavior based on the readiness of the patient to modify the patient's behavior for the at least one of the displayed plurality of target behaviors, and
adding the selected one of the plurality of displayed target behaviors to the target behaviors of the patient, and adding the selected one of the plurality of displayed target behaviors to at least one of: a visit's notes, a progress notes, and a patient's instructions.

7. The method of claim 5, wherein the step in response to the clinician entering the readiness of the patient to modify the patient's behavior for at least one of the displayed plurality of target behaviors, comprises:
in response to the clinician entering the readiness of the patient to modify the patient's behavior for at least one of the displayed plurality of target behaviors, selecting one of the plurality of displayed target behaviors as the new target behavior based on the readiness of the patient to modify the patient's behavior for the at least one of the displayed plurality of target behaviors, and
adding the selected one of the plurality of displayed target behaviors to the target behaviors of the patient, and adding to a patient's instructions for the selected one of the plurality of displayed target behaviors key messages and resources to help the patient.

8. The method of claim 1, the step in response to receiving information identifying the patient and an indication of a beginning of a clinical session, comprises:
in response to receiving information identifying the patient and an indication of a beginning of a clinical session, retrieving stored patient data from a database, and displaying portions of the retrieved patient data for a clinician to update during the clinical session, said displayed data comprising goals of the patient, a goal status indicator, target behaviors of the patient to achieve the goals, and a readiness of the patient to adopt the target behaviors.

9. The method of claim 1, wherein the step in response to receiving a selection for finding a new target behavior to achieve the goals of the patient, comprises:
in response to receiving a selection for finding a new target behavior to achieve the goals of the patient, displaying a matrix of strategies, and
in response to receiving readiness selections for a plurality of strategies displayed in the matrix of strategies, identifying one of the plurality of strategies for the patient to achieve the goal, and
displaying a plurality of target behaviors for the patient to achieve the goals of the patient, wherein the displayed plurality of target behaviors for the patient to achieve the goals of the patient are selected based on the identified strategy.

10. The method of claim 9, wherein the step in response to receiving a selection for finding a new target behavior to achieve the goals of the patient, further comprises:
displaying a readiness ruler.

11. The method of claim 9, wherein the step in response to receiving a selection for finding a new target behavior to achieve the goals of the patient, further comprises:
displaying an agenda for the clinician to follow to identify a strategy from the matrix of strategies.

12. The method of claim 1, wherein the step in response to receiving a selection for finding a new target behavior to achieve the goals of the patient, comprises:
in response to receiving a selection for finding a new target behavior to achieve the goals of the patient, displaying a plurality of target behaviors for the patient to achieve the goals of the patient, wherein the plurality of target behaviors are selected from a library of target behaviors.

13. The method of claim 1, wherein the step in response to receiving a selection of one of the plurality of displayed target behaviors as the new target behavior, comprises:
in response to receiving a selection of one of the plurality of displayed target behaviors as the new target behavior, adding the selected one of the plurality of displayed target behaviors to the target behaviors of the patient, wherein the selection of the one of the plurality of displayed target behaviors is based on a readiness of the patient to adopt the selected one of the plurality of displayed target behaviors.

14. The method of claim 1, further comprising:
in response to receiving updates to displayed patient data, updating the patient data with the received updates, and adding the received updates to at least one of: a visit's notes, and a progress notes.

15. The method of claim 14, further comprising:
sending to the patient via at least one of email or a text message an aggregation of updated displayed patient data.

16. The method of claim 14, further comprising:
prompting the clinician to update retrieved patient data.

17. The method of claim 1, wherein the step in response to receiving a selection for finding a new target behavior to achieve the goals of the patient, comprises:
in response to receiving a selection for finding a new target behavior to achieve the goals of the patient, displaying a plurality of domains, and
in response to receiving a selection of one of the plurality of displayed domains, displaying a matrix of strategies, and
in response to receiving readiness selections for a plurality of strategies displayed in the matrix of strategies, identifying one of the plurality of strategies for the patient to achieve the goal, and
displaying a plurality of target behaviors for the patient to achieve the goals of the patient, wherein the displayed plurality of target behaviors for the patient to achieve the goals of the patient are selected based on the identified strategy.

18. A computer program product, comprising:
a computer-readable medium comprising:
a first set of codes for responding to receiving information identifying a patient by retrieving stored patient data from a database, and displaying portions of the retrieved patient data for a clinician to update during a clinical session, said displayed data comprising goals of the patient, target behaviors of the patient to achieve the goals, and a readiness of the patient to adopt the target behaviors;
a second set of codes for responding to receiving a selection for finding a new target behavior to achieve the goals of the patient by displaying a plurality of target behaviors for the patient to achieve the goals of the patient;
a third set of codes for responding to receiving a selection of one of the plurality of displayed target behaviors as the new target behavior by adding the selected one of the plurality of displayed target behaviors to the target behaviors of the patient; and
a fourth set of codes for storing the selected one of the plurality of displayed target behaviors to the database.

19. A computer system for clinician decision support for behavior modification of a patient, the system comprising:
a processor adapted to:
respond to receiving information identifying the patient by retrieving stored patient data from a database, and displaying portions of the retrieved patient data for a clinician to update during a clinical session, said displayed data comprising goals of the patient, target behaviors of the patient to achieve the goals, and a readiness of the patient to adopt the target behaviors;
respond to receiving a selection for finding a new target behavior to achieve the goals of the patient by displaying a plurality of target behaviors for the patient to achieve the goals of the patient;
respond to receiving a selection of one of the plurality of displayed target behaviors as the new target behavior by adding the selected one of the plurality of displayed target behaviors to the target behaviors of the patient; and
store the selected one of the plurality of displayed target behaviors to the database.

20. The computer system of claim 19, wherein the processor is further adapted to:
display an agenda for the clinician to follow to identify a new target behavior for the patient to achieve the goal and displaying target behaviors for the patient to achieve the goal.

21. The computer system of claim 19, wherein the processor is adapted for the step to respond to receiving a selection for finding a new target behavior to achieve the goals of the patient, by
displaying a plurality of target behaviors for the patient to achieve the goals of the patient, and to respond to the clinician entering a readiness of the patient to modify the patient's behavior for at least one of the displayed plurality of target behaviors by selecting one of the plurality of displayed target behaviors as the new target behavior based on the readiness of the patient to modify the patient's behavior for the at least one of the displayed plurality of target behaviors, and adding the selected one of the plurality of displayed target behaviors to the target behaviors of the patient.
